(19) United States
(12) Patent Application Publication
(10) Pub. No.: US 2003/0015223 A1
(43) Pub. Date: Jan. 23, 2003

(54) Methods of cleaning containers using ozone compositions

(75) Inventors: Tracey Jacksier, Lisle, IL (US); V.S. Meenakshi Sundaram, Burr Ridge, IL (US); Steven A. Fisher, Lyons, IL (US); Robert Benesch, Clarendon Hills, IL (US); Bruce Talbert, Chicago, IL (US)

Correspondence Address: Jeffrey L. Wendt, 600 Town Center One, 1450 Lake Robbins Drive, The Woodlands, TX, 77380, US

(73) Assignee: American Air Liquide, Inc., Fremont, CA

(21) Appl. No.: 10/157,536

(22) Filed: May 29, 2002

Related U.S. Application Data
(60) Provisional application No. 60/306,012, filed on Jul. 17, 2001.

(51) Int. Cl. B08B 9/08

(52) U.S. Cl. 134/22.18

(57) ABSTRACT

Methods of cleaning metal containers, and containers having internal metal linings are described. The methods comprise the steps of exposing the internal metallic surface to a composition comprising ozone, the internal metallic surface having thereon a residue, contacting the composition comprising ozone with the internal metallic surface for a time sufficient to either remove the residue, chemically modify the residue to form a modified residue that may be removed by other means, or deactivate the residue.

### CROSS REFERENCE TO RELATED APPLICATIONS

This application claims priority from copending provisional application serial No. 60/306,012, filed Jul. 17, 2001, incorporated herein by reference.

### BACKGROUND OF THE INVENTION

1. Field of the Invention

The invention is generally related to the field of cleaning compositions and methods of their use. More specifically, the invention relates to using compositions comprising ozone in cleaning containers, more particularly the interior of metallic containers meant to hold certain gaseous compositions, to increasing the shelf-life of the products in the containers, and to container/product combinations.

2. Related Art

In the manufacture of certain metallic containers, residues are sometimes left from the manufacturing process, or are generated prior to filling the containers with their intended product. The intended product may either be a pure product, or a mixture of two or more components. In the case of so-called “specialty gases”, the product is typically a pure or diluted version of a particular gas or gas mixture.

For example, in certain industries it is critical to ascertain the amount of hydrogen sulfide (H₂S) in an atmosphere to ensure worker safety. At certain concentrations, H₂S smells like “rotten eggs”, but at certain other concentrations it is odorless, and workers may be over come by the gas without even knowing the gas is present at lethal levels. These facts make it imperative that specialty gas “standards” are available for use in ascertaining the concentration of certain gases, so that frequent safety checks may be made. If the container has a residue from the manufacturing process, or contains residue generated after the manufacturing process while waiting for its standard product to be loaded therein, there exists the possibility that the specialty gas may not properly perform its intended function. The concentration of the specialty gas may not be what is labeled on the container, or presumed by the user, due to instability of the product in the presence of the residue. In other words, the shelf-life of the product may be reduced, sometimes from years to days (and in some cases to hours). Therefore, it has become imperative to find a way to clean metallic containers, or containers having metallic inner surfaces, to remove residues which might have these deleterious effects.

U.S. Pat. No. 6,255,222, from the semiconductor manufacturing art, describes a chemical deposition chamber connected to a downstream plasma apparatus (“DPA”), the deposition chamber and plasma apparatus connected by a “foreline”. The patent describes a method of keeping the foreline clean in a deposition process that reacts an organosilane gas and ozone to deposit a carbon-doped silicon oxide or other type film on a substrate disposed in the chamber, and prevents or at least minimizes the build up of an organic polymer material within the DPA connected to the foreline. In one embodiment, the method solves the organic material/organic polymer build up problem by forming a plasma within the DPA during the deposition process of the carbon-doped silicon oxide layer while the deposition gas, which includes oxygen, is flowed into the chamber. It is believed that oxygen from the deposition gas that is exhausted from the chamber into the DPA readily reacts, under plasma conditions, with carbon atoms from the residue or particulate matter collected within the DPA to form carbon monoxide (CO), carbon dioxide (CO₂) and steam (H₂O) among other volatile products. The oxygen exhausted into the DPA may be unreacted ozone or molecular oxygen, oxygen ions, oxygen-containing reaction byproducts and/or the like, that are exhausted from the chamber during the chamber clean process. There is, however, no discussion of metallic containers; cleaning of metallic containers, or removal of organic materials or organometallic materials from metallic containers.

U.S. Pat. No. 5,676,762 (Kimura et al.) discloses a process for reducing corrosion in a gas distribution network of ultra high purity gas or any part of said distribution network, including: (a) wet cleaning the gas distribution network or at least one part thereof with a wet cleaning agent, (b) liquid drying the gas distribution network or the at least one part thereof with an H₂O desorbing liquid drying agent selected from the group consisting of acetone dimethylacetal (DMP), 2,2-dichloropropane (DCP) or 2,2-dibromopropane (DBP), mixtures thereof and any equivalent thereof, (c) purging said gas distribution network or any part thereof with a dry high purity gas comprising less than 1 ppm of any impurity, and (d) evacuating the gas distribution network or any part thereof at a pressure which is lower than 5×10⁴ Pascal (e) exposing the gas distribution network or any part thereof to an atmosphere including an ultra high purity corrosive gas or air. Such gas distribution systems are typically made using stainless steel components. Again, however, there is no mention of cleaning metallic containers, or of cleaning containers at all which may have a residue left from their manufacturing process.

U.S. Pat. No. 4,724,819, from the automotive engine field, discloses an engine cylinder liner reconditioning process and cylinder liner produced thereby. This patent explains that diesel engines are generally often intended for heavier duty use than, for instance, gasoline engines. Therefore, regarding strength, they are generally overbuilt and moreover, are usually constructed to higher tolerances. This dramatically increases the cost of a diesel engine as opposed to a gasoline engine. Accordingly, it is desirable to enable the owner/operator to recover some of this expense by prolonging the useful life of the engine. As a result, diesel engines are commonly provided with cylinder liners. The use of cylinder liners can extend engine life by allowing more extensive use of water jackets and coolant passages, thereby providing a cooler running engine. A cooler running engine is further obtained because cylinder liners are generally better heat conductors than the engine block, from which the cylinder walls would otherwise be formed. This is simply because the engine block is formed, for reasons of strength and cost, of cast iron or cast aluminum. In contrast, the cylinder liner need be neither particularly strong nor particularly cheap, and the choice of suitable alloys is therefore not so limited. Accordingly, the liner may be chosen of any appropriate long wearing, heat conductive material. The patent discloses engine cylinders (for example aluminum) having a multilayer coating of a base layer, a steel layer and a layer of a tetrafluoroethylene fluorocarbon polymer, i.e., a “Teflon” wear surface. As may be determined, such a process for making an aluminum cylinder usable is labor-intensive and quite expensive in order that aluminum may be used at all.

Ozone is known as a powerful oxidant, and is used in a variety of industries: for example the pulp and paper industry to bleach pulp white; in the semiconductor industry to clean silicon wafers; and the food industry to disinfect surfaces which may come in contact with food or food packaging. However, its use has not been pronounced in the metal cleaning art. U.S. Pat. No. 5,062,900 discloses a process for improving the corrosion resistance of a metallic material, such as steel, aluminum, titanium, and alloys of the same, characterized in that the metallic material is subjected cold to a surface treatment by a low-temperature plasma, at a pressure of 1 to 10³ Pa in an atmosphere comprising at least one gas chosen from the following: oxygen, ozone, nitrogen, hydrogen, air, carbon dioxide, carbon monoxide, the oxides of nitrogen, water, combustion gases and mixtures of these with a neutral gas. The inventors deduced from data that the treatment eliminates the surface contaminators of the material, such as for example, P and Si; that the treatment is limited to the passivated layer in the case of stainless steels (50 to 100 A); there is neither nitriding, nor carburizing, nor implantation (as proved by the SLD analysis); and the treatment consists of a modification of the state of the surface via passivation and/or amorphisation. Unfortunately, the use of a low temperature, and below atmospheric pressure plasma increases the cost of the process.

It is generally known that ozone reacts with organic, inorganic and organometallic containing compounds containing aliphatic and/or aromatic moieties. However, from the above it is clear that there is currently no acceptable way to deactivate or remove residues from, or modify residues in, metallic containers at pressure near atmospheric pressure, without the use of exotic plasmas and other means. It would be advantageous if compositions and methods of their use could be provided which address the need for methods to remove, chemically modify, or deactivate organic and/or organometallic residues in containers meant to store stable standards, with long shelf-life for testing purposes and other purposes.

### SUMMARY OF THE INVENTION

In accordance with the present invention, methods are presented for cleaning metallic containers and containers having metallic liners which may have an organic, inorganic or organometallic residue left on their inside surface after manufacture, or generated during storage. Using the methods of the present invention, shelf-life of products stored in the containers is significantly increased, especially when the container is subsequently passivated in accordance with the teachings of assignee's co-pending application Ser. No. ______, filed simultaneously herewith, and incorporated herein by reference.

One method of the invention using a composition comprising ozone to remove residues from an internal metallic surface of a container comprises the steps of:

a) exposing the internal metallic surface to a composition comprising ozone, the internal metallic surface having thereon a residue; and

b) contacting the composition comprising ozone with the internal metallic surface for a time sufficient to either:

i) remove the residue; or

ii) chemically modify the residue to form a modified residue that may be removed by other means.

A second method of the invention comprises using a composition comprising ozone to deactivate residues from an internal metallic surface of a container comprises the steps of:

a) exposing the internal metallic surface to a composition comprising ozone, the internal metallic surface having thereon a residue; and

b) contacting the composition comprising ozone with the internal metallic surface for a time sufficient to deactivate the residue. As used herein the term “deactivate” means that the residue is made non-reactive by chemical modification, so that the deactivated residue does not react with the gas to be stored in the container.

Preferred methods within the invention are those wherein the residue is selected from the group consisting of organic material and organometallic material; methods wherein the composition comprising ozone is selected from the group consisting of gaseous compositions and liquid compositions; and methods wherein the composition comprising ozone comprises a chemical selected from the group consisting of nitrogen, argon, helium, hydrogen, oxygen, a halogen, and mixtures thereof. Other preferred methods are those comprising the step of generating the composition comprising ozone prior to the exposing step; methods comprising the step of generating the composition comprising ozone during the exposing step; and methods wherein the container is selected from the group consisting of cylinders, tanks, ton units, tube trailers, spheres, and bullets. Yet other preferred methods are those wherein the modified residue is removed by other means selected from the group consisting of liquid chemical washing, gas purging, heating, baking, vacuum, scrubbing, and combinations of these. Preferred methods include those wherein the composition comprising ozone has an ozone concentration ranging from about 1 to about 20 percent, and wherein the internal metallic surface comprises metals selected from the group consisting of aluminum, aluminum alloy, nickel, and steel (either carbon or stainless steel).

Other aspects and advantages of the invention will become apparent upon reading the following description of preferred embodiments.

### BRIEF DESCRIPTION OF THE DRAWING

FIGS. 1 and 2 illustrate schematically how gaseous compositions comprising ozone are preferably used in accordance with the invention;

FIGS. 3 and 4 illustrate schematically how liquid compositions comprising ozone are preferably used in accordance with the invention;

FIG. 5 illustrates that using passivation alone will not achieve a stable gas concentration when starting with a dirty container; and

FIG. 6 illustrates that gas samples in cylinders which have been both cleaned and passivated will be useable as standard gases at least over a period of 80 days.

### DESCRIPTION OF PREFERRED EMBODIMENTS

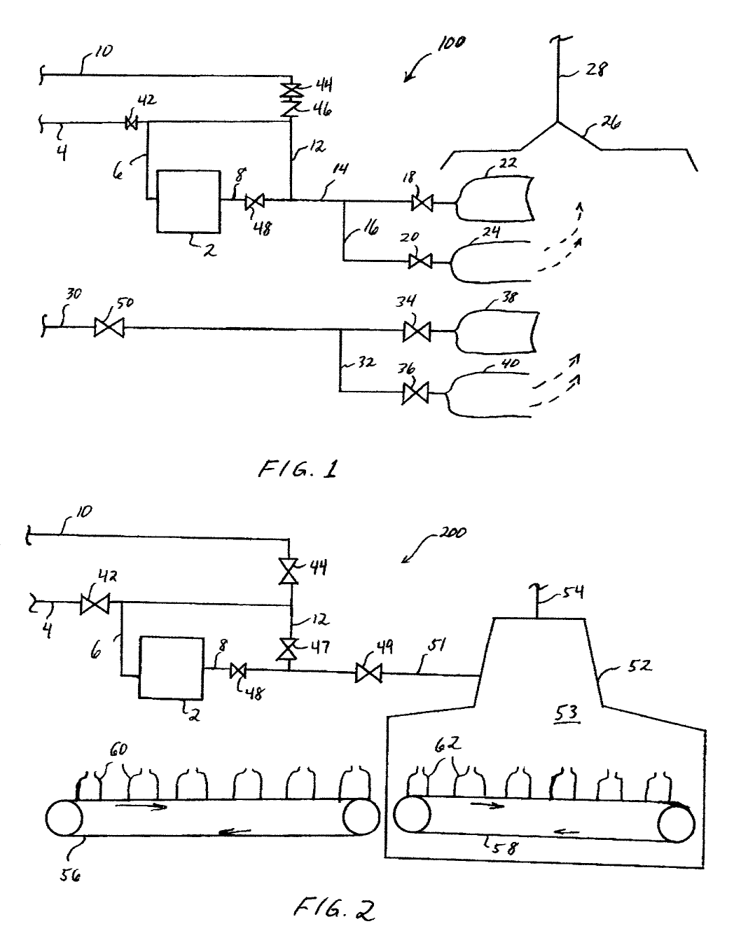

Referring now to the drawings, FIG. 1 illustrates one embodiment 100 of an apparatus for carrying out the methods of the invention using gaseous ozone. Apparatus 100 includes an ozone generator, 2 which is fed by conduits 4 and 6 with a gas containing oxygen. The gas containing oxygen may be commercially pure oxygen, air or oxygen-enriched air. Ozone generators are well known in the art and their operation deserves little explanation here. Commercial ozone generators are generally divided into small and medium size units as well as large scale units. Ozone generators known under the trade designation OZAT®, available from Ozonia, North America, Elmwood Park, N.J. are suitable for use in the invention depending on the size needed. A typical ozone system will comprise five separate steps: feed gas preparation, ozone generation, heat exchange, ozone contacting, and vent gas collection. As stated in the Ozonia website, these stages are typically separate subsystems that can be integrated into a single process by a centralized controller. The first step results in a contaminant-free, high-purity feed gas. The second generates ozone. The third step removes the excess heat produced by the ozone generation process. The fourth step contacts the ozonated gas stream with the container to be treated. Residual ozone is removed from the vent gas in the final stage of the process before the gas is sent to the atmosphere or recycled. If oxygen is used as a feed gas, the product gas exiting ozone generator 2 in line 8 will be anywhere from 5 to 15 percent ozone with the balance being oxygen. If air is used as feed gas, the product exiting ozone generator 2 in line 8 will be anywhere from 1 percent to 3 percent ozone, with the balance being oxygen, nitrogen, and trace amounts of argon, carbon dioxide and other air gases.

Ozone-containing gas in conduit 8 proceeds through a valve 48 and then may or may not not mix with an optional carrier gas, which enters through conduits 10 and 12 and through valves 44 and 46. Preferred carrier gases are inert gases, selected from the group consisting of nitrogen, argon, mixtures thereof, and similar inert gases. Inert gases are preferred because many residues have the capability to be explosively reactive with ozone and oxygen, as explained further herein. The ozone containing gas proceeds through conduits 14 and 16 and valves 18 and 20 to contact either a closed container 22 or an open end container 24. Closed container 22 preferably allows a more intimate contact of ozone with internal surface of container 22, but would require that container 22 be exchanged for another container upon completion of ozone treatment. Container 24, illustrated as open ended, preferably allows the spent ozone gas, including unreacted ozone and any vapor or particulate residue, to exit as illustrated by the dotted arrows through a hood system 26 and then to conduit 28. Conduit 28 preferaby includes an ozone destruct unit (not illustrated).

Also illustrated in FIG. 1 is a conduit 30, valve 50, conduit 32 and valves 34 and 36, all of which allow a purge gas to purge closed container 38 and open ended container 40. Purging preferably follows the contacting of the internals of the container with the ozone-containing gases as depicted in containers 22 and 24. However, purging could occur before the ozone-containing gas contacts the containers, or both before and after the ozone contacting step.

FIG. 2 illustrates another embodiment, 200, of a gas treatment apparatus in accordance with the present invention. As in FIG. 1, an ozone generator 2 is fed with oxygen, air, or oxygen-enriched air through conduits 4 and 6, producing an ozone-containing gas in conduit 8 which traverses through valve 48. Optional carrier gas traverses through conduits 10 and 12 and valves 44 and 47 and mixes with the ozone-containing gas traveling through conduit 8. Ozone-containing gas, either combined with or without a carrier gas, traverses through conduit 51 and valve 49 and enters an enclosed space defined by a building construction 52. Building construction 52 includes a chamber 53 in which the ozone-containing gas is allowed to contact the internals of containers 62 which in turn are being moved on a conveyer system or other means 58. Conveyer system 58 is in turn fed by a conveyer 56 on which fresh, untreated containers 60 are carried. Building construction 52 also includes a vent conduit 54, which preferably includes an ozone destruct unit (not illustrated).

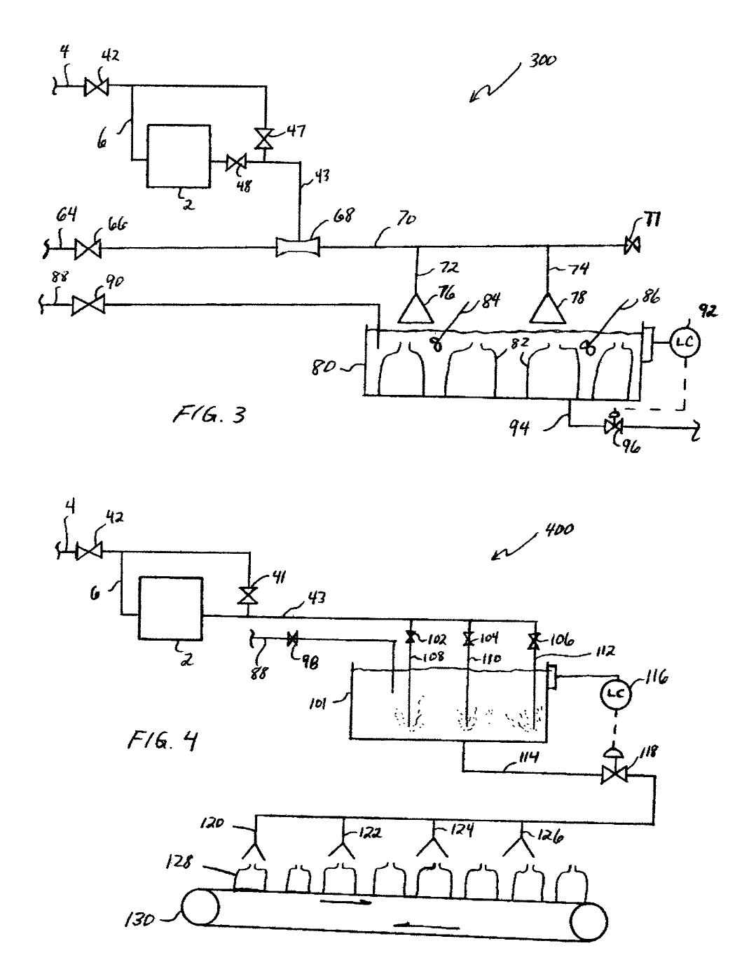

FIGS. 3 and 4 illustrate two embodiments, 300 and 400 respectively, demonstrating how an ozone-containing liquid, preferably ozone-containing water, would be used in treating containers in accordance with the present invention.

FIG. 3 illustrates embodiment 300, which includes an ozone generator 2, which is fed oxygen, air, or oxygen-enriched air through conduits 4 and 6 and valve 42 as in previous embodiments. Ozone-containing gas exits ozone generator 2 and travels through conduit 43 and valve 48. A bypass valve 47 is preferably provided in conduit 4 to allow bypass of ozone generator 2.

Ozone-containing gas in conduit 43 is aspirated by a flowing liquid stream, such as an aqueous stream in conduit 64, which flows through valve 66 and venturi 68. The action of venturi 68 creates a low pressure region allowing ozonated gas in conduit 43 to be merged with the fluid traversing in conduit 64 to create an ozonecontaining liquid, which subsequently enters conduit 70. Conduit 70 in turn feeds conduits 72 and 74, which in turn feed spray nozzles 76 and 78, respectively. Conduit 70 preferably ends with a valve 77 or a blind flange (not illustrated). Ozone-containing liquid from spray devices 76 and 78 enters a tank 80 or other vessel designed to hold ozone-containing liquid. Tank 80 preferably has capacity for multiple containers 82 to be treated. Optional stirring devices 84 and 86 may be provided to provide turbulence for the ozonated liquid. Optionally, surfactants and other additives may be supplied to tank 80 via means such conduit 88 and valve 90. A level control means 92 preferably controls a flow of waste ozone-containing liquid through conduit 94 and control valve 96. Tank 80 may also include a hood device for collecting ozone vapors and an associated ozone destruct unit, which are not illustrated for simplicity.

FIG. 4 illustrates an alternate embodiment 400 for creating an ozone-containing liquid. The apparatus 400 includes, as in previous embodiments, an ozone generator 2 which is fed by a feed gas through conduits 4 and 6. Again the feed gas would be oxygen, air or oxygen-enriched air. Ozone generator 2 produces an ozone-containing gas which flows through conduit 43 and subsequently into conduits 108, 110, and 112, as directed by valves 102, 104, and 106, respectively. While any number of means may be used to disperse an ozone-containing gas in a liquid, embodiment 400 in FIG. 4 illustrates simply a series of open-ended conduits 108, 110, and 112. The terminus of these conduits preferably lies submerged beneath a level of a liquid which is held in tank 101. Tank 101 is fed liquid via conduit 88 and valve 98. A level control means 116 controls a level control valve 118, which in turn controls flow of ozonated-liquid through a conduit 114. Conduit 114 in turn feeds conduits 120, 122, 124, and 126 allowing a spray of ozone-containing liquid onto and into containers 128 to be treated. Containers 128 travel, for example, on a conveyer 130, or other material handling means.

A variety of means for cleaning may be employed, for example spargers, dip tubes, hollow wands with a brush attached to its end, a hose with spray nozzle attached to its end, and all are considered useful means for applying compositions comprising ozone. Methods such as explained in the following U.S. patents may be useful: U.S. Pat. No. 6,348,227 describes methods of spraying gases and mixtures comprising ozone and water on meat carcasses in a food processing system to minimize microbial growth while an animal, such as a chicken, is processed into food; U.S Pat. 6,346,201 describes sparging methods; U.S. Pat. No. 6,334,578 describes a spray hood assembly; U.S. Pat. No. 6,345,404 describes water-cleaning apparatus involving spraying and brushes. These patents are incorporated herein by reference for their teaching of these means.

The action of ozone on the residue preferably results in oxidation of the residue. As previously stated it is generally known that ozone reacts with organic, inorganic and organometallic-containing compounds containing unsaturated and/or aromatic moieties. By way of example, and not limitation, reactions of alkenes with ozone are preferably carried out by contacting ozone-containing gas with the alkene in the presence of an inert solvent at low temperatures (preferably 0° C., more preferably less than −80° C.). Suitable solvents for ozonations of this type include methylene chloride, alcohol, and ethyl acetate. The resulting ozonide structure hydrolyzes with water readily to give carbonyl compounds and hydrogen peroxide, which are easily removed.

Organometallic compounds which may be removed or modified in containers in the processes of the invention include t-butyllithium, diethylnagnesium, trimethylaluminum, dipropylcadmium, diethylzinc, dimethylmercury, methylcopper, tetramethylsilicon, tetraethyllead, triethylborane, triethylstannane, ethyltrimethylsilane, ethylmagnesium bromide, methylmercuric chloride, ethylaluminum dichloride, and the like. Organometallic compounds in which the metal has an electronegativity value of about 1.7 or less react with water to give the hydrocarbon and a metal hydroxide. Alkyllithium, alkylmagnesium, and alkylaluminum compounds react violently with water. Such compounds react similarly with other hydroxylic compounds, such as alcohols and carboxylic acids. They also react with other compounds having relatively acidic hydrogens, such as thiols and amines. While the containers to be treated in accordance with the present invention are not likely to have excessive amounts of residues to be removed, compositions useful in the inventions are preferably formulated with solvents having few acidic hydrogens. Organometallic compounds of many metals react rapidly with oxygen, and therefore with ozone. Because of this high reactivity with oxygen and ozone, it is common to carry out the reactions of organometallic compounds with oxygen and ozone under inert atmospheres by use of such gases such as nitrogen and argon as carrier gases with the ozone-containing gas.

As mentioned previously, and in particular regarding embodiments where ozone-containing liquids are used, preferably other additives, such as surfactants may be used. These additives may either be used in mixture with the ozone-containing liquid, or used as an after wash solution, in other words, as a wash solution after the ozone-containing liquid or ozone-containing gas treatment. One suitable liquid composition would be that as disclosed in U.S. Pat. No. 4,414,128, which is incorporated by reference herein. This patent discloses a liquid detergent composition, particularly for use as a hard surface cleaner, comprising from 1 to 20% surfactant, from 0.5% to 10% mono or sesquiterpenes, and from 0.5% to 10% of a polar solvent having a solubility in water ranging from 0.2% up to 10%, preferably benzyl alcohol. As stated in the '128 patent, these compositions provide good cleaning of both greasy and particulate soils, improved surface appearance, and excellent formulation, homogeneity, and stability.

Preferred terpenses are mono- and bicyclic-monoterpenes, especially those of the hydrocarbon class, which can be selected from terpinenes, terpinolenes, limonenes and pinenes. Highly preferred materials of this type include d-limonene, diapentene, and the mixture of terpene hydrocarbons obtained from the essence of oranges.

The polar solvent is preferably one having a solubility in water of from about 0.2% to about 10% by weight, for example benzyl alcohol. These detergent compositions also preferably contain from about 0.005% to about 2% of an alkaline metal, ammonium or aluminoammonium soap of a C₁₃-C₃₄ fatty acid. Preferably, the fatty acid is fully saturated, for example by hydrogenation of naturally occurring fatty acids.

A calcium sequestrant is also desirable in the detergents. These materials provide not only cleaning advantages on particulate soil, but also advantages in terms of product homogenaity and stability. The sequestrant is typically selected from water-soluble salts of polyphosphates, and added at a level in the range of from 1-9%.

As stated in the '128 patent, a wide range of anionic, nonionic, zwitterionic and amphoteric surfactants can be used, either alone as a single component or a mixture with a detergent composition such as described in the '128 patents. Suitable anionic non-soap surfactants are water-soluble salts of alkyl benzene sulfonates, alkyl sulfates, paraffin sulfonates, and the like.

Examples of suitable nonionic surfactants include the condensation products of alkyl phenols having an alkyl group containing from 6 to 12 carbon atoms with ethylene oxide; the condensation product of primary or secondary aliphatic alcohol is having from 8 to 24 carbon atoms with alkaline oxide; and compounds formed by condensing ethylene oxide with a hydrophobic base formed by the condensation of propylene oxide with either propylene glycol or ethylene diamine.

Suitable ampholytic surfactants are water-soluble derivatives of aliphatic secondary and tertiary amines in which the aliphatic moiety can be a straight chain or branched and wherein one of the aliphatics substituants contains from about 8 to 18 carbon atoms and one contains an anionic water-solublizing group, for example carboxy, sulfonate, sulfate, phosphate, or phosphonate.

Suitable zwitterionic surfactants are water-soluble derivatives of aliphatic quaternary ammonium, phosphonium, and sulfonium cationic compounds in which the aliphatic moieties can be straight chain or branched, and wherein one of the aliphatic substituents contains from about 8 to 18 carbon atoms and one contains an anionic water-solublizing group.

In the first aspect of the invention it is mentioned that the contacting of the container with a composition comprising ozone is sufficient to either (1) remove the residue, or (2) chemically modify the residue to form a modified residue that may be removed by other means. This is also true in the second aspect of the invention (a method of making a package product contained in a container).

Residues may be removed by a variety of mechanical means such as scrubbing, grinding, and peening. Scrubbing may be performed with non-woven abrasives, such as disclosed in U.S. Pat. Nos. 2,958,593, 4,991,362, and 5,025,596. The use of lofty, fibrous, nonwoven abrasive products for scouring surfaces such as the soiled surfaces of pots and pans is well known. These products are typically lofty, nonwoven, open mats formed of staple fibers which are bonded together at points where they intersect and contact each other. The staple fibers of low-density abrasive products of this type can be, and typically are, bonded together at points of contact with a binder that may or may not contain abrasive particles. The staple fibers are typically crimped, have a length of about 3.8 cm, a diameter ranging from about 25 to about 250 micrometers, and are formed into lofty open webs by equipment such as “Rando-Webber” and “Rando-Feeder” equipment (marketed by the Curlator Corporation, of Rochester, N.Y. and described in U.S. Pat. Nos. 2,451,915; 2,700,188; 2,703,441 and 2,744,294). One very successful commercial embodiment of such an abrasive product is that sold under the trade designation “Scotch-Brite” by Minnesota Mining and Manufacturing Company of St. Paul, Minn. (“3M”). Low-density abrasive products of this type can be prepared by the method disclosed by Hoover et al. in U.S. Pat. No. 2,958,593. While such abrasive products have had excellent commercial success, their production requires a considerable investment in equipment. A “Rando-Webber” web-forming machine, for example, can cost in the thousands of dollars. Additionally, the fibers used to form the web of such abrasive products typically require chopping to produce staple fibers which is both costly and time consuming.

Low-density, lofty abrasive products may also be formed of webs or mats of continuous filaments. For example, in U.S. Pat. No. 4,227,350, Fitzer discloses a low-density abrasive product comprising a uniform cross-section, generally flat-surfaced, open, porous, lofty web of autogenously bonded, continuous, undulated, interengaged filaments. The web of Fitzer is formed by downwardly extruding a plurality of thermoplastic organic (e.g. polyamide, polyester) filaments from a spinneret into a quench bath. As the filaments enter the quench bath, they begin to coil and undulate, thereby setting up a degree of resistance to the flow of the molten filaments, causing the molten filaments to oscillate just above the bath surface. The spacing of the extrusion openings from which the filaments are formed is such that, as the molten filaments coil and undulate at the bath surface, adjacent filaments touch one another. The coiling and undulating filaments are still sufficiently tacky as this occurs, and, where the filaments touch, most adhere to one another to cause autogenous bonding to produce a lofty, open, porous, handlable filament web. The web, so formed, is then impregnated with a tough binder resin which adherently bonds the filaments of the web together and also bonds a multitude of abrasive granules, uniformly dispersed throughout the web, to the surface of the filaments. Fibrous polishing and/or abrading materials can be prepared from continuous or substantially continuous synthetic filaments by the method disclosed by Zimmer et al., in U.S. Pat. No. 3,260,582. In this method crimped or curled continuous filaments are straightened out under tension into a substantially parallel relationship with one another, uniformly coated while under tension with an adhesive which may or may not contain abrasive particles, interlocked with one another by release of such tension and then set in a permanently interlocked and lofty, open, 3-dimensional state by curing or setting up the adhesive. Low-density, lofty, open, porous, nonwoven scouring articles have been more easily and economically manufactured from continuous filaments by the method disclosed by Heyer et al., in U.S. Pat. Nos. 4,991,362, and 5,025,596. The scouring pads described in these patents comprise a multiplicity of crimped or undulated, continuous, thermoplastic organic filaments that are bonded together (e.g., by fusion or an adhesive) at opposite ends. The pad is made by arranging a multiplicity of continuous, crimped or undulated, thermoplastic organic filaments in an open lofty array, with one point of each filament in the array corresponding to a first filament bonding site and a second point of each filament, distant from the first point, corresponding to a second filament bonding site. A pad is formed in the filament array by bonding substantially all of the thermoplastic organic filaments together at the first and second bonding sites. When a pad having greater abrasiveness is desired, abrasive particles may be adherently bonded to the filaments of the pad, preferably before the individual pad is cut from the filament array. These pads have also enjoyed commercial success and are economical to make. U.S. Pat. No. 5,363,604 describes nonwoven scouring articles comprising a low-density, lofty, open, porous, nonwoven web, the web comprising a multiplicity of crimped or undulated, continuous, preformed thermoplastic organic filaments, at least partially coated with an organic thermoset binder which binds the filaments at least at a portion of points where they contact. The continuous thermoplastic organic filaments, preferably in the form of tow, are entangled together at a multiplicity of points along their length to provide a cross-direction tensile strength the web of at least about 0.02 kg/cm, more preferably at least about 0.03 kg/cm, before coating the web with a thermosetting binder precursor solution. The continuous filaments are “entangled”, preferably by needlepunching from a plurality of directions perpendicular to the machine direction. Other background references include U.S. Pat. Nos. 3,688,453; 4,622,253; 4,669,163; 4,902,561; 4,927,432; 4,931,358; and 4,935,295; World Patent Application No. WO 92/01536, published Feb. 6, 1992; European Patent Application number 0 492 868 A1, published Jul. 1, 1992, the disclosures of which are incorporated herein by reference.

Other means of removing residues from metal surfaces include grinding, such as by using so-called bonded abrasive wheels, disks, or cones or bonded abrasives produced in other shapes. Bonded abrasives which may be used for this purpose are such as those described in U.S. Pat. Nos. Abrasive products comprising a solid or foamed organic polymeric matrix having abrasive granules dispersed throughout and bonded therein are well known and widely used. Typically, the polymeric matrix is composed of either a hard, thermoset resin, such as a catalyzed phenol-formaldehyde, or resilient elastomer, such as a polyurethane or a vulcanized rubber.

Bonded abrasives are to be distinguished from coated abrasives in their construction and mode of operation. Bonded abrasives (e.g., grinding wheels) are three-dimensional structures of binder and abrasive grains which rely upon the continual breakdown and removal of the abrasive grains on the cutting surface to continually present sharp cutting points to the material being ground. Coated abrasives, on the other hand, typically have only a single layer of abrasive grains. See, or example, U.S. Pat. No. 5,011,512, incorporated herein by reference.

When elastomeric binder matrices are used in bonded abrasives they generally produce an abrasive article having some degree of flexibility and resiliency. These abrasive articles typically provide a smoother abrasive action and a finer surface finish than that provided by a bonded abrasive article made with hard, thermoset resin. As a result of this, elastomeric bonded abrasive articles have found a wide range of industrial applications, such as deburring, finishing, and sanding in the metal and wood-working industries. However, often these elastomeric bonded abrasive articles have shown premature loss of abrasive particles and, in some cases, undesirable smearing or transfer of portions of the elastomeric binder to the surface of the workpiece.

Conventional flexible bonded abrasive articles typically employ an elastomeric polyurethane as the binder matrix. The polyurethane binder matrix may be a foam, as disclosed in U.S. Pat. Nos. 4,613,345; 4,459,779; 2,972,527; 3,850,589; UK Patent Specification No. 1,245,373 (published Sep. 8, 1971); or the polyurethane binder may be a solid, as disclosed in U.S. Pat. Nos. 3,982,359; 4,049,396; 4,221,572, and 4,933,373. these patents are incorporated herein by reference for their teaching of the use of bonded abrasives to clean metallic surfaces.

For very large containers, such as ton units, bullets, and spheres, peening may be used with success to remove residues, scales and other deposits on internal surfaces of these containers. U.S. Pat. Nos. 3,638,464 and 3,834,200 (incorporated herein by reference) disclose a high-intensity peening flap construction which includes an elongate strap of a flexible, tear-resistant material, and at least one metal peening particle support base fastened to the elongate strap. A plurality of refractory-hard, impact fracture-resistant peening particles are metallurgically joined to an exposed face of the support base. In use, one or more of the flaps are mounted on a hub, and the hub is rotated while the flaps are forced against the workpiece to be peened. The peening particles on each support base strike the workpiece in turn, thereby causing the peening particles to perform their normal peening function, but preventing the normal uncontrolled scattering which occurs in conventional shot peening. Improvements to these articles are described in U.S. Pat. Nos. 5,179,852 and 5,203,189, incorporated herein by reference where necessary to understand their use in removing residues. Mechanical cleaning may be used either before or after exposure to the ozone-containing gas or ozone-containing liquid. Cycles may be envisioned where exposure to ozone containing gas or ozone containing liquid is performed, followed by abrasion with a non-woven or bonded abrasive or roto peening, followed by a second exposure to ozone-containing fluid, followed by a second abrasion step, and so on.

### EXAMPLES

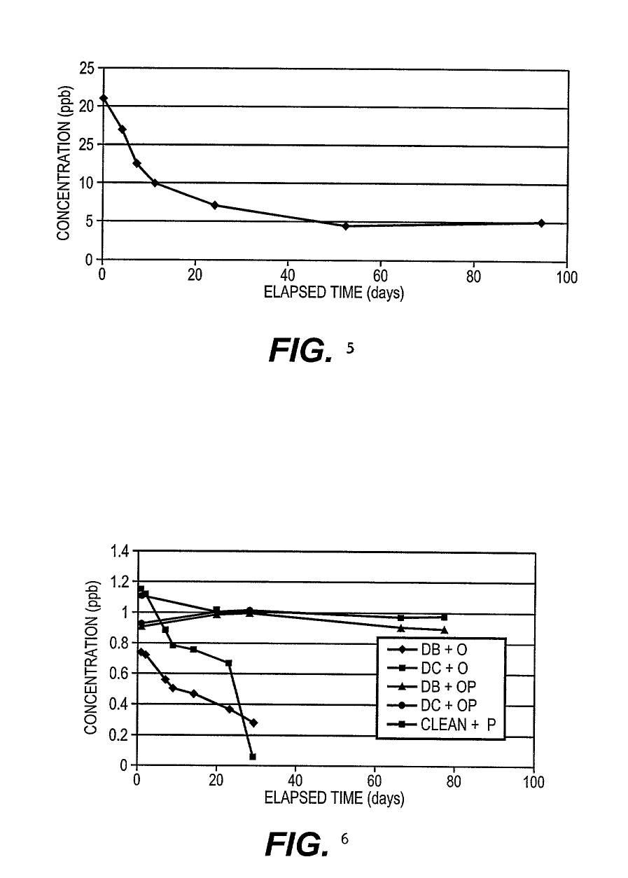

Comparative Example 1. FIG. 5 illustrates data gathered for H₂S held in an originally “dirty” cylinder (in other words a cylinder that had organometallic residues of unknown character) that had been passivated using silane prior to loading a composition comprising 20 ppm H₂S, balance nitrogen. During passivation, a 1 percent silane balance nitrogen mixture was introduced into an aluminum cylinder and left in the cylinder overnight. Subsequently the balance was vacuumed out and the cylinder was filled with a 20 ppm H₂S balance nitrogen mixture. As may be seen, the concentration dropped to 10 ppm in about 11 days. This example demonstrates that using passivation alone will not work when starting with a dirty container.

Examples 1, 2 and 3 and Comparative Examples 2 and 3. FIG. 6 illustrates data collected for 5 different gas/cylinder combinations. Curves labeled “DB+O” (Comparative Example 2) and “DC+O” (Comparative Example 3) designated cylinders that were both initially dirty with organometallic residues, and were subsequently cleaned using ozone compositions in accordance with the present invention. These two cylinders were then filled with nominal 1 ppm H₂S balance nitrogen compositions. It can be seen that ozone cleaning alone was not successful in maintaining shelf-life. On the other hand, data represented by the curve labeled “clean+P” (Example 1) was a clean cylinder (in other words a new cylinder) that had been passivated as described in Comparative Example 1. It is thus seen that new, passivated cylinders will be acceptable. The data for the two cylinders labeled “DB+OP” (Example 2) and “DC +OP” (Example 3) were for two dirty cylinders cleaned in accordance with the present invention, and then passivated and filled with nominal 1 ppm H₂S. FIG. 6 illustrates that these gas sample will be useable as standard gases at least over a period of 80 days.

Although the description herein is intended to be representative of the invention, it is not intended to limit the scope of the appended claims.

What is claimed is:

1. A method of using a composition comprising ozone to remove residues from an internal metallic surface of a container, the method comprising the steps of:
a) exposing the internal metallic surface to a composition comprising ozone, the internal metallic surface having thereon a residue; and
b) contacting the composition comprising ozone with the internal metallic surface for a time sufficient to either:
i) remove the residue; or
ii) chemically modify the residue to form a modified residue that may be removed by other means.

2. The method of claim 1 wherein said residue is selected from the group consisting of organic material and organometallic material.

3. The method of claim 1 wherein said composition comprising ozone is selected from the group consisting of gaseous compositions and liquid compositions.

4. The method of claim 1 wherein said composition comprising ozone comprises a chemical selected from the group consisting of nitrogen, argon, helium, hydrogen, oxygen, a halogen, and mixtures thereof.

5. The method of claim 1 comprising the step of generating said composition comprising ozone prior to said exposing step.

6. The method of claim 1 comprising the step of generating said composition comprising ozone during said exposing step.

7. The method of claim 1 wherein the container is selected from the group consisting of cylinders, tanks, ton units, tube trailers, spheres, and bullets.

8. The method of claim 1 wherein the other means are selected from the group consisting of liquid chemical washing, gas purging, heating, baking, vacuum, scrubbing, abrading, and combinations of same.

9. The method of claim 1 wherein said composition comprising ozone has an ozone concentration ranging from about 1 to about 20 percent.

10. The method of claim 1 wherein said internal metallic surface comprises metals selected from the group consisting of aluminum, aluminum alloy, nickel, and steel.

11. A method of using a composition comprising ozone to deactivate residues on an internal metallic surface of a container, the method comprising the steps of:
a) exposing the internal metallic surface to a composition comprising ozone, the internal metallic surface having thereon a residue; and
b) contacting the composition comprising ozone with the internal metallic surface for a time sufficient to deactivate the residue.

12. The method of claim 11 wherein said residue is selected from the group consisting of organic material and organometallic material.

13. The method of claim 11 wherein said composition comprising ozone is selected from the group consisting of gaseous compositions and liquid compositions.

14. The method of claim 11 wherein said composition comprising ozone comprises a chemical selected from the group consisting of nitrogen, argon, helium, hydrogen, oxygen, a halogen, and mixtures thereof.

15. The method of claim 11 comprising the step of generating said composition comprising ozone prior to said exposing step.

16. The method of claim 11 comprising the step of generating said composition comprising ozone during said exposing step.

17. The method of claim 1 wherein the container is selected from the group consisting of cylinders, tanks, ton units, tube trailers, spheres, and bullets.

18. The method of claim 11 wherein said composition comprising ozone has an ozone concentration ranging from about 1 to about 20 percent.

19. The method of claim 11 wherein said internal metallic surface comprises metals selected from the group consisting of aluminum, aluminum alloy, nickel, and steel.
